(19) United States
(12) Patent Application Publication
(10) Pub. No.: US 2008/0247808 A1
(43) Pub. Date: Oct. 9, 2008

(54) Paint Roller with Integral Paint Delivery Mechanism

(76) Inventor: Michael D. Costigan, Boynton Beach, FL (US)

Correspondence Address: JOHN C. SMITH, ESQ., 2499 GLADES ROAD, SUITE 113, BOCA RATON, FL, 33431, US

(21) Appl. No.: 11/971,870

(22) Filed: Jan. 9, 2008

Related U.S. Application Data
(60) Provisional application No. 60/910,812, filed on Apr. 9, 2007.

(51) Int. Cl. B05C 17/02; B05B 9/01; A47L 13/00

(52) U.S. Cl. 401/219; 401/137

(57) ABSTRACT

A combination roller/spray gun device with a spray gun nozzle that is held in alignment with a paint roller, and sprays paint at a predetermined point on a surface in front of the roller. A pressurized supply of paint is provided to a trigger controlled paint supply valve at the proximal end of the paint roller device. A removable nozzle/conduit assembly extends from the paint supply valve to the distal end of paint roller device. The nozzle/conduit assembly is secured inside of the shaft of the paint roller device by a removable roller assembly.

### CROSS-REFERENCE TO RELATED APPLICATIONS

This non-provisional patent application is related to, and claims the benefit of, currently pending Provisional Patent Application Ser. No. 60/910,812, filed Apr. 9, 2007, titled “Paint Roller with Integral Paint Delivery Mechanism,” and naming Michael D. Costigan, the named inventor herein, as sole inventor, and is hereby incorporated herein in its entirety.

### BACKGROUND

1. Technical Field

The present invention relates to painting equipment. In particular, it relates to a paint roller device which has an integral paint supply and paint sprayer.

2. Background of the Invention

A variety of paint application devices have been developed to more efficiently complete painting operations. For example, fixed handheld brushes have been used for many years. These bristle brush devices can be constructed from any number of materials, such as horse hair, synthetic fibers, etc., and are well known in the art. Later, paint rollers were developed. Paint rollers provide a substantial increase in the speed and ease with which paint can be applied to flat surfaces, and due to their efficiency, they have been in widespread use since their invention. Another innovation has been the development of the pressurized paint spray gun. The use of spray guns has further increased the speed at which paint can be applied to a surface.

The choice of a brush, paint roller, or a spray gun is dictated by the nature of the surface to which the paint (or other liquid) will be applied. For example, conventional bristle-type paint brushes are useful for painting rough surfaces, or surfaces having an irregular shape. While they are slow as application devices, they provide the painter with a device that is capable of doing precision work. In addition to the slowness of paint brushes, there is another problem with the paint supply. In particular, the paint is kept in a container which must be continuously used to replenish the brush. This wastes a substantial amount of time during the painting process. Moving the brush between the target surface and the paint container also often results in paint dripping on floors or other surfaces. This wastes paint, and requires the expenditure of additional time for cleanup. Another disadvantage of the paint brush is that paint is typically not applied evenly. When paint is applied by a paint brush, the painter will usually spend a substantial amount of time rebrushing the same surface to ensure an even coat of paint.

A significant advantage provided by the paint roller is that it can rapidly apply paint to a large surface area. While the conventional paint roller is much faster than a paint brush, it shares the disadvantage with the paint brush that the paint roller must be moved between the painting surface and the paint container. As was the case with the paint brush, dripping problems and cleanup time may be excessive. Paint rollers also have the disadvantage in that they are most useful for large smooth surfaces, such as walls or ceilings. Likewise, there are not particularly useful for rough or irregular surfaces.

In an attempt to address this problem, rollers have been developed which are filled with paint that is extruded through the roller. A paint supply is attached to the paint roller device, and the paint is forced into through apertures in the roller as needed. This type of device is well-known in the art. A disadvantage associated with this type of roller is that paint extruded through apertures in the roller may clog, causing uneven paint distribution. To ensure that paint is evenly applied, the painter may be required to make several passes over a particular area.

Spray guns are another method of applying paint or other liquids to a surface. Spray guns are also well known in the art. Spray guns may use pressurized air to eject atomized liquid particles from a nozzle, or form a high pressure fluid stream which a nozzle designed to disperse the stream in a particular manner. In either configuration, the spray gun nozzle is connected to a paint (or liquid) container. The system is pressurized to provide a constant flow of paint. Spray guns have a disadvantage in that, when liquids are sprayed onto a surface under high pressure, they often create overspray which results in paint being applied where it is not desired. This requires extra cleanup effort. Spray guns can also be difficult to use in terms of their ability to provide a uniform coating on a surface.

Combination paint rollers and spray guns have also been created by the prior art. The combination roller/spray gun devices typically eject a stream of paint from the spray gun's nozzle which is deposited onto the surface of the roller to spread the paint (or other liquid) across the surface. A drawback with this device is that it is typically a complex device with an excessive weight. This creates fatigue for the painter and is prone to mechanical failures. Further, because the distance between the nozzle and the surface is not fixed, paint stripes of varying width may be created. An alternative roller/spray gun device uses dual rollers to allow application of paint in both directions. However, this requires an even more complicated dual roller system that is heavier, more inconvenient to use, and has more components to fail.

Another drawback associated with prior art devices is that they are inconvenient to clean and maintain. This is especially true for the cleaning process for the shaft which holds the roller at its distal end. When moving from one paint job to another, paint residue in the device must be removed so that it does not contaminate the paint used for the next job.

The prior art has failed to provide a roller/spray gun device which is lightweight, which has a minimum number of components, which provides an assembly that can easily be disassembled and cleaned, and which has a roller and spray gun which are automatically and precisely aligned with one another.

### SUMMARY OF THE INVENTION

The present invention provides a combination roller/spray gun device with a spray gun nozzle that is held in alignment with a paint roller, and sprays paint at a predetermined point on a surface in front of the roller. A pressurized supply of paint is provided to a trigger controlled paint supply valve at the proximal end of the paint roller device. A removable nozzle/conduit assembly extends from the paint supply valve to the distal end of paint roller device. The nozzle/conduit assembly is secured inside of the shaft of the paint roller device by a removable roller assembly.

### BRIEF DESCRIPTION OF THE DRAWINGS

FIG. 1 is a perspective view of a prior art roller/spray gun device.

FIG. 2 is a side view of a preferred embodiment of the roller/spray gun device.

FIG. 3 is a top view of a preferred embodiment of the roller/spray gun device.

FIG. 4A is a top view of an alternative preferred embodiment of the roller/spray gun device that connects to a paint source having a separate paint gun. This figure shows the paint gun disconnected from the roller/spray gun device.

FIG. 4B is a top view of the alternative preferred embodiment of the roller/spray gun device of FIG. 4A showing the paint gun attached to the roller/spray gun device.

FIG. 4C is a top view of the alternative preferred embodiment of the roller/spray gun device of FIG. 4A. This figure illustrates the preferred method of cleaning the device.

### DETAILED DESCRIPTION OF THE PREFERRED EMBODIMENT

Prior to a detailed discussion of the figures, a general overview of the system will be presented. The invention provides a roller/spray gun device which improves the manner in which paint is applied to surfaces, and further improves upon pre-existing roller/spray gun devices. The device uses a spray gun nozzle which is automatically aligned with a roller such that the paint is applied to correct location on the surface in front of a roller. The automatic alignment ensures that the paint is not sprayed in too wide or too narrow a swath. Further, the paint nozzle is positioned such that it automatically has the correct distance from the surface to reduce the chances that paint will impact the surface with excessive force which in turn causes splattering. The advantage of automatically aligning the spray nozzles with the paint conduit is that any painter can achieve superior results by not having to manually adjust the paint nozzle to the roller.

Another advantage provided by the invention is that it uses a one-piece paint conduit which is mounted inside the shaft of the paint roller/spray gun device. Several advantages are gained from this structural configuration. To begin with, paint conduit is protected from accidental damage from impact, or accidental damage caused by the paint conduit snagging on other objects.

The one-piece structure of the paint conduit provides an additional advantage in that it allows the device to be quickly and easily assembled or disassembled. For a professional painter, the ability to quickly disassemble and clean a painting device reduces the work effort and labor costs associated with preparation for the next painting job. In the preferred embodiment, the paint roller/spray gun is disassembled as follows. The roller assembly is first disconnected from the shaft. Another use of the roller assembly is to secure the paint conduit in the shaft. The paint conduit is envisioned as a single rigid tube which extends from the paint supply valve at the proximal end of the shaft to the distal end of the shaft. The paint conduit is removably secured at one end to the paint supply valve, and at the distal end it extends through a slot in the shaft. It is secured to the shaft by the roller assembly when assembled. Optionally, a locking ring may be used to further secure the paint conduit in position.

When the roller/spray gun device is assembled, paint is applied to the input of the paint supply valve. When the valve is opened, the paint flows through the paint conduit to the paint nozzle. Because the paint nozzle is automatically aligned with the roller when assembled, the painter can quickly assemble the device and begin work. Once the paint job is complete, the painter merely reverses the process by detaching the roller assembly, detaching the paint conduit from the paint supply valve for cleaning or repair. Those skilled in the art will recognize that the paint roller/spray gun can also be cleaned without disassembly by attaching a supply of solvent or other cleaning fluid to the input of the paint supply valve, and running the solvent through the device under pressure.

Having discussed the features and advantages of the invention in general, we turn now to a more detailed discussion of the figures.

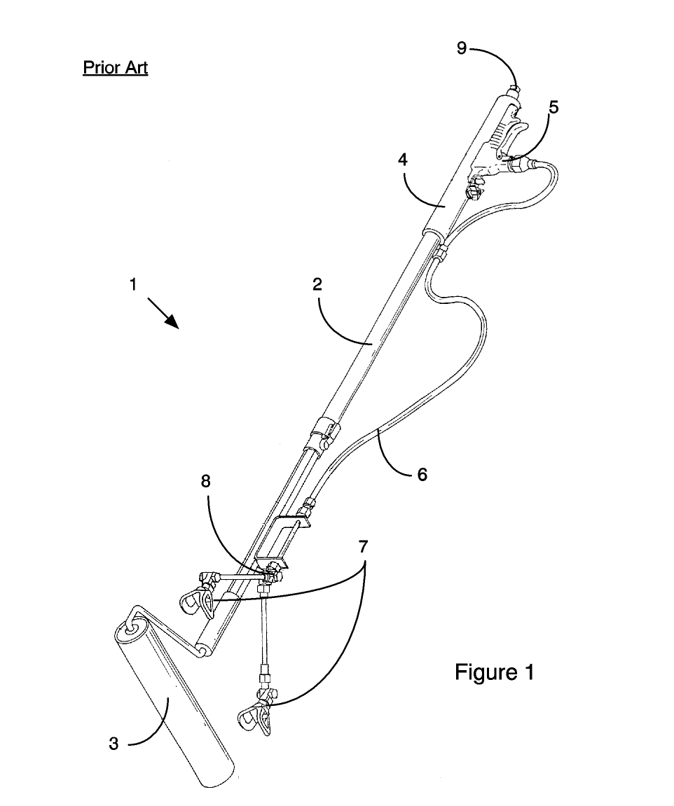

In FIG. 1, a prior art roller/spray gun 1 is shown. In this figure, a shaft 2 is secured to a handle 4 at its proximal end. The roller assembly 3 is in turn secured to the shaft 2 at the distal end of shaft 2. In this device, the paint supply valve 5 is embedded into the handle 4, and attached to the paint supply input port 9. During normal operation, a supply of pressurized paint (not shown) is attached to the paint supply input port 9. The output of the paint supply valve 5 is attached to the proximal end of paint conduit 6. Paint conduit 6 is attached to the nozzle assembly 8. Nozzle assembly 8 catches 21 or more paint nozzles 7 which are adjustable.

When a painter activates the paint supply valve 5, paint moves through the paint supply valve 5 and into paint conduit 6. The paint exits in conduit 6 and enters the nozzle assembly 8 or misdirected to the paint nozzles 7. This particular configuration has several drawbacks. First, the paint conduit 6 is exposed to impact damage or damage from snagging on other items. Further, the device has multiple components which must be aligned. As will be shown below, Applicant's invention provides a much simpler structure with reduced component count, automatic alignment, and a convenient method of assembly and disassembly for cleaning or repair.

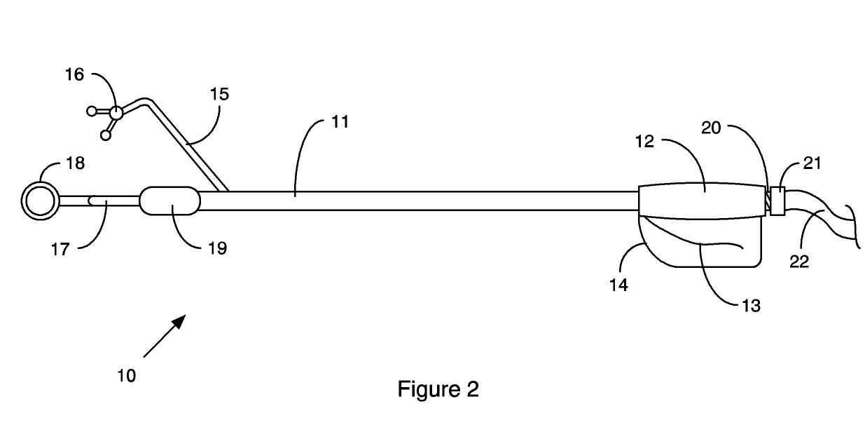

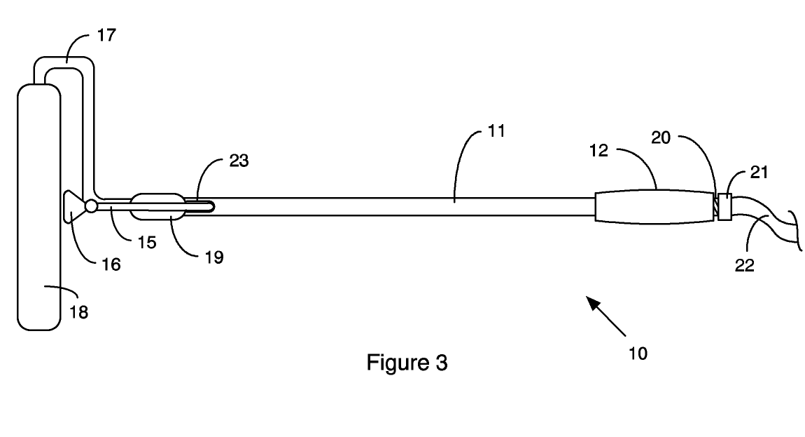

FIG. 2 is a side view of a preferred embodiment of the roller/spray gun 10 which embodies the invention. This can be seen by comparison with the prior art FIG. 1, the roller/spray gun 10 provides a greatly simplified structure which is easier to maintain and clean. In this configuration, a shaft 11 has a handle 12 secured to its proximal end. The handle 12 has an internal paint supply valve (not shown in this figure) which is controlled by trigger 13. A trigger guard 14 as also shown surrounding trigger 13 and preventing its accidental discharge. A paint input port 20 extends from the proximal end of the roller/spray gun 10. During use, a paint supply hose 22 is secured to the paint input port 20 by connector 21. A paint conduit 15 is secured to the paint supply valve and extends through shaft 11 and exits at slot 23 (shown below in FIG. 3) near the distal end of shaft 11. Paint conduit 15 is secured in position and automatically aligned by the slot 23.

The paint roller assembly is secured to the distal end of shaft 11. Paint roller assembly is comprised of paint roller 18, paint roller support arm 17, and paint roller handle 19. During use, when the trigger 13 is activated, paint moves through paint conduit 15 to paint nozzle 16. Paint nozzle 16 is automatically adjusted such that the paint is sprayed onto the surface just in front of the paint roller 18. Typically, the painter would spray paint when the paint roller 18 is moving toward the sprayed paint, and would stop spraying when the paint roller 18 is moving in the opposite direction.

FIG. 3 is a top view of a preferred embodiment of the roller/spray gun 10 which embodies the invention. This view illustrates slot 23 which secures paint conduit 15. For ease of illustration, slot 23 is shown with paint conduit 15 loosely set within it. In practice, paint conduit 15 would snuggly fit within slot 23 so that it is held in alignment with the paint roller 18. In the preferred embodiment, paint conduit 15 is secured to the output of the paint supply valve by a bushing that holds the proximal end of the paint conduit 15 by a pressure fit. The distal end of paint conduit 15 is secured in slot 23 by paint roller handle 19. By securing the paint conduit 15 at both ends in this manner, it can be easily inserted or removed when needed. In addition, the paint conduit 15 and paint nozzle 16 are automatically aligned with the paint roller 18.

For ease of illustration, only one paint nozzle 16 is shown. However, those skilled in the art will recognize that more than one paint nozzle 16 can be attached to paint conduit 15. Further, those skilled in the art will recognize that any suitable material can be used to fabricate the paint conduit 15 or other components of the roller/spray gun 10.

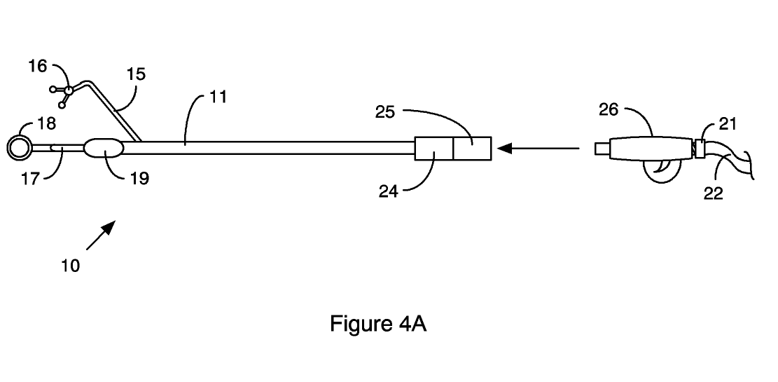

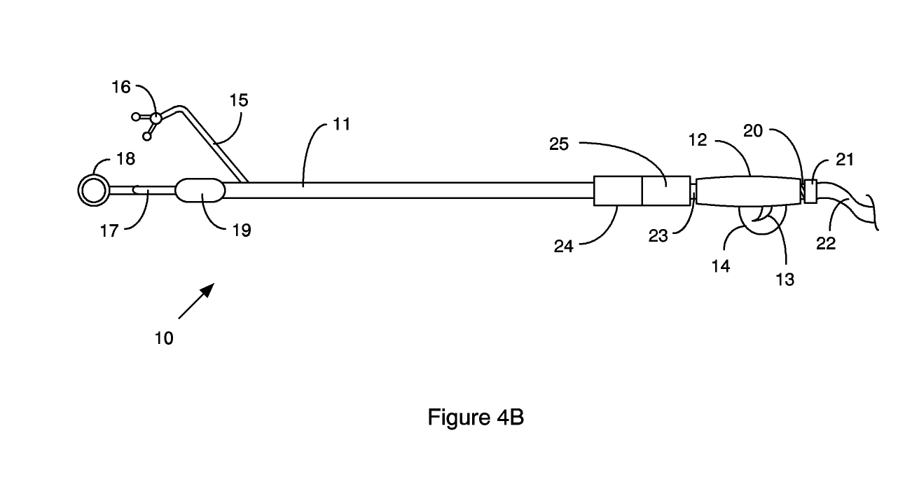

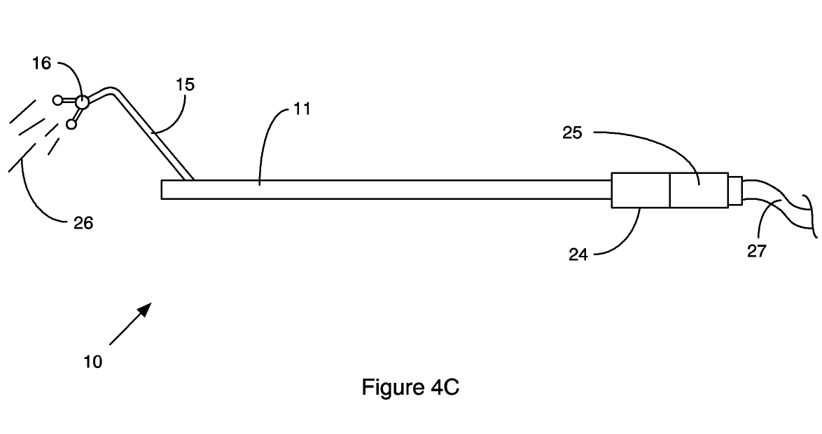

FIG. 4A is a top view of an alternative preferred embodiment of the roller/spray gun device 10 that connects to a paint source that includes a paint supply hose 22 and a paint gun 26. This figure shows the paint gun 26 disconnected from the roller/spray gun device 10. During use, the paint gun 26 is removably attached to handle 24, and secured by quick disconnect attachment 25. An advantage provided by this embodiment is that it provides a simplified structure that can be used in conjunction with conventional spraying devices.

FIG. 4B is a top view of the alternative preferred embodiment of the roller/spray gun device 10 of FIG. 4A showing the paint gun 26 attached to the roller/spray gun device 10 and secured by quick disconnect attachment 25.

FIG. 4C is a top view of the alternative preferred embodiment of the roller/spray gun device 10 of FIG. 4A. This figure illustrates the preferred method of cleaning the roller/spray gun device 10. In particular, cleaning can be accomplished by pressing a water hose 27 against the aperture in quick disconnect attachment 25 of handle 24. The water 26 is flushed through the roller/spray gun device 10 and exits at paint nozzle 16. This provides the painter with a convenient and quick way to clean the roller/spray gun device 10. This figure also shows the paint roller 18, paint roller support arm 17, and paint roller handle 19 removed for cleaning in the conventional manner.

While the invention has been described with respect to a preferred embodiment thereof, it will be understood by those skilled in the art that various changes in detail may be made therein without departing from the spirit, scope, and teaching of the invention. For example, the material used to construct the roller/spray gun device may be anything suitable for its purpose, the size and shape of the components used by the roller/spray gun device can vary. The type and number of paint nozzles can vary. The liquid sprayed can be paint or any other liquid that is applied to a large surface, etc. Accordingly, the invention herein disclosed is to be limited only as specified in the following claims.

I claim:

1. A paint roller/spraying device, further comprising:
a shaft having a distal end and a proximal end;
a handle near or at the proximal end of the shaft;
a paint input port near or at the proximal end of the shaft;
means to removably attach a paint roller to the distal end of the shaft;
a paint conduit having distal and proximal ends, the paint conduit disposed within the shaft, the paint conduit attached at its proximal end to the output of the paint input port and providing a path for paint entering the paint input port through the paint conduit; and
a paint nozzle attached to the distal end of the paint conduit.

2. A device, as in claim 1, further comprising:
a paint supply valve disposed between the paint input port and the paint conduit, the paint supply valve having an open position that allows paint to flow from the paint input port into the paint conduit and a closed position to prevent paint from flowing from the paint input port to the paint conduit.

3. A device, as in claim 2, wherein:
the paint conduit extends out of the shaft near the distal end of the shaft.

4. A device, as in claim 3, wherein:
the portion of the paint conduit that extends out of the shaft near the distal end of the shaft is secured in place such that it does not move in relation to the shaft.

5. A device, as in claim 4, further comprising:
a slot in the shaft near its distal end; and
the paint conduit extends out of the shaft via the slot, the slot sized such that it prevents the paint conduit from rotating.

6. A device, as in claim 4, wherein:
the paint conduit is formed or bent such that when a paint roller is attached to the device, the paint nozzle is aimed such that, when the paint roller is moved in a first direction, paint sprayed from the paint nozzle under control of the paint supply valve is directed to a surface in the path of the paint roller and in front of the path of the paint roller.

7. A device, as in claim 6, wherein:
a plurality of paint nozzles are attached to the paint conduit, each paint nozzle is aimed such that, when the paint roller is moved in a first direction, paint sprayed from the paint nozzles under control of the paint supply valve is directed to a surface in the path of the paint roller and in front of the path of the paint roller.

8. A device, as in claim 2, wherein:
means to attach a supply of water or cleaning fluid to the paint input port such that the paint supply valve, the paint conduit, and the paint nozzle are cleaned when the water or cleaning fluid flows through the device.

9. A device, as in claim 1, further comprising:
a paint supply valve or paint spray gun detachably attached to the paint input port, the paint supply valve or paint spray gun having an open position that allows paint to flow into the paint input port and a closed position to prevent paint from flowing into the paint input port.

10. A device, as in claim 9, wherein:
the handle further comprises quick disconnect means to attach or detach the paint supply valve or paint spray gun to the paint input port.

11. A device, as in claim 10, wherein:
the paint conduit extends out of the shaft near the distal end of the shaft.

12. A device, as in claim 11, wherein:
the portion of the paint conduit that extends out of the shaft near the distal end of the shaft is secured in place such that it does not move in relation to the shaft.

13. A device, as in claim 12, further comprising:
a slot in the shaft near its distal end; and
the paint conduit extends out of the shaft via the slot, the slot sized such that it prevents the paint conduit from rotating.

14. A device, as in claim 12, wherein:
the paint conduit is formed or bent such that when a paint roller is attached to the device, the paint nozzle is aimed such that, when the paint roller is moved in a first direction, paint sprayed from the paint nozzle under control of the paint supply valve is directed to a surface in the path of the paint roller and in front of the path of the paint roller.

15. A device, as in claim 14, wherein:
a plurality of paint nozzles are attached to the paint conduit, each paint nozzle is aimed such that, when the paint roller is moved in a first direction, paint sprayed from the paint nozzles under control of the paint supply valve is directed to a surface in the path of the paint roller and in front of the path of the paint roller.

16. A device, as in claim 10, wherein:
means to attach a supply of water or cleaning fluid to the paint input port such that the paint supply valve, the paint conduit, and the paint nozzle are cleaned when the water or cleaning fluid flows through the device.

17. A method of painting with an extended shaft paint roller/spraying device, including the steps of:
inputting paint into the proximal end of an extended shaft under pressure;
spraying paint from a nozzle at or near the distal end the shaft; and
adjusting the nozzle such that the paint spray is automatically aimed such that it sprays in the path of, and in front of, a paint roller attached to the proximal end of the shaft.

18. A method, as in claim 17, including the additional steps of:
attaching a supply of water or cleaning fluid to the extended shaft; and
cleaning the extended shaft by passing a supply of water or cleaning fluid through it.

19. A method, as in claim 17, including the additional step of:
using a plurality of paint nozzles to extend the width of the paint spray.

20. A method, as in claim 17, including the additional steps of:
extending a paint conduit out of the shaft near the distal end of the shaft; and
securing the paint conduit that extends out of the shaft by retaining the extended portion of the paint conduit in a slot in the shaft.
